(19) United States
(12) Patent Application Publication
(10) Pub. No.: US 2008/0127129 A1
(43) Pub. Date: May 29, 2008

(54) COMPILING LOGICAL PROGRAMS TO REWRITE SYSTEMS

(75) Inventors: David E. Langworthy, Kirkland, WA (US); Steven E. Lucco, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/468,552

(22) Filed: Aug. 30, 2006

(51) Int. Cl. G06F 9/45

(52) U.S. Cl. 717/140; 717/136

(57) ABSTRACT

Transformation of logic programming into rewrite programming. First, a concrete expression of logic programming is converted into an abstract expression of logic programming. The abstract expression of logic programming is then transformed into an abstract expression of rewrite programming. The rewrite programming may ultimately be compiled or interpreted and executed. Accordingly, rather than performing complex unification involved with logic programming, the processing of the programming may simply involve perform matching, which is typically faster from an execution perspective.

### BACKGROUND

Computing technology is enabled by the interaction between computer hardware and software. The software, when executed by one or more processors, directs the functionality of computing systems through the appropriate use of system hardware, and interprets appropriate responses to events detected by the hardware.

Programming languages are a valuable tool that computer programmers often use to generate source code that, when compiled and/or interpreted, become the machine readable instructions that are actually executed by the computer. Programming languages define a set of concrete syntax that the computer programmer may use to describe the functionality of the computer program using source code. The syntactical rules followed by the programming language are designed to offer an intuitive mechanism to formulate the software.

There are, at present, a number of different categories of programming languages including, logic programming and rewrite programming. In this description and in the claims, “logic programming” is any programming that uses predicates that include only horn clauses, the predicates having arguments and the predicate being first order. For example, consider the following logical predicate described in equation 1.

P(X)̂ Q(x)→R(x) (1)

This predicate represents a horn clause because it is an implication (as represented by it being an equation that includes the symbol “→” that has only one result of the implication (in the example, R(x)). Furthermore, the predicate has arguments. Specifically, each of the functions P, Q and R has one argument x. Furthermore, the predicate is first order in that none of the arguments are themselves predicates. Therefore, equation 1 represents a valid example of logic programming.

The following Equations 2 through 4 are examples of clauses that do not represent logic programming under the definition provided above.

p→Q (2)

read as “P implies Q”

P(x)̂ Q(x)→R(x)̂ S(X) (3)

read as “P(x) and Q(x) implies R(x) and S(x)”

P(R(x))→Q(x) (4)

Equation 2 is not an example of logic programming as the term “logic programming” is defined herein since none of the predicates “P” and “Q” include an argument. Equation 3 is not an example of logic programming as defined herein since there are two results of the implication (i.e., R(x) and S(x)), and therefore Equation 3 is not a horn clause. Equation 4 is not an example of logic programming as defined herein since the argument of one of the predicates is itself a predicate. In other words, R(x) is a predicate and an argument of P(x). Therefore, Equation 4 is not first order.

Logic programming is quite powerful in that it permits unification to thereby support a higher level, more declarative programming model. Unification is an automated and sometimes quite complex logical deduction process in which bound and unbound variables are kept track of while solving for the unbound variables. The position of the variables within a concrete expression of logic programming does not necessarily imply anything about whether the variable is bound or unbound. While unification is powerful and allows for a lot of flexibility in the expression of bound and unbound variables within the programming language, the execution is often relatively slow.

Furthermore, logic programming and the associated unification processes may need special runtime support, and might not be supported by a standard runtime environment such as the common language runtime (CLR) or even runtimes for functional languages such as Lisp, F#, ML, and Haskell.

Rewrite programming, on the other hand, does not work on the principles of unification and therefore requires no such support from an underlying runtime. It is, in fact, its own runtime. Every runtime has an associated language, the CLR has MSIL, Warren Abstract Machine (WAM) has Prolog, Intel processors have x86, and so forth. Rewrite programs do not need to keep track of which variables are bound and which variables are unbound to thereby perform logic deduction unification processes. Instead, rewrite systems perform simple matching. In other words, one expression is searched for, and if a match is found, the expression is replaced by another expression.

Since rewrite programs do not require complex logic deduction-based unification, rewrite programs are typically executed much more quickly. Furthermore, since rewrite programs are their own common runtime environment, they do not need to rely on the system having other common runtime environments in order to operate properly.

### BRIEF SUMMARY

Although not required, embodiments of the present invention relate to the transformation of logic programming into rewrite programming. First, a concrete expression of logic programming is converted into an abstract expression of logic programming or the abstract expression of logic programming is accessed in some other way. The abstract expression of logic programming is then transformed into an abstract expression of rewrite programming. The rewrite programming may ultimately be compiled or interpreted and executed. In one embodiment, the concrete expression of logic programming may be converted into a concrete expression of rewrite programming. Accordingly, rather than performing complex unification involved with logic programming, the processing of the programming may simply involve matching, which is typically faster from an execution perspective.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The appended drawings are used in order to more particularly describe embodiments of the present invention. Understanding that these drawings depict only typical embodiments of the invention and are not therefore to be considered to be limiting of its scope, the embodiments will be described and explained with additional specificity and detail through the use of the accompanying drawings in which:

FIG. 1 illustrates a computing system in which embodiments of the principles of the present invention may operate;

FIG. 2 illustrates a flowchart of a method for transforming logic programming into rewrite programming in accordance with the embodiments of the principles of the present invention;

FIG. 3 illustrates a schematic environment including symbolic representations of concrete and abstract expressions of logic and rewrite programming, and various relevant transformations; and

FIG. 4 illustrates a flowchart of a method for transforming an abstract logic expression into an abstract rewrite expression in accordance with embodiments of the present invention.

### DETAILED DESCRIPTION

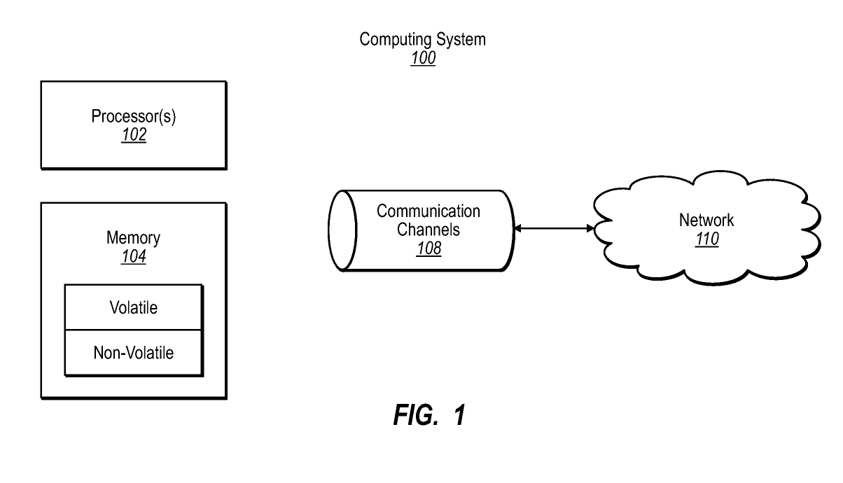

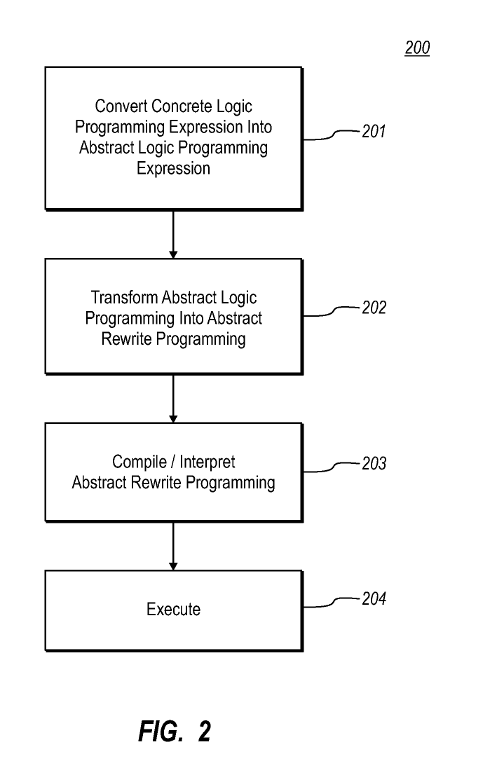

Embodiments of the present invention extend to the transformation of logic programming into rewrite programming. First, an example computing system in which the principles of the present invention may operate will be described with respect to FIG. 1. Then, an example of multi-mode logic programming will be provided along with an example trace for queries corresponding to each of the multiple modes supported by the logic programming. In conclusion, embodiments of the present invention will be described with respect to FIG. 2 through 4.

FIG. 1 shows a schematic diagram of an example computing system 100 that may be used to implement embodiments of the present invention. The described computing system is only one example of such a suitable computing system and is not intended to suggest any limitation as to the scope of use or functionality of the invention. Neither should the invention be interpreted as having any dependency or requirement relating to any one or combination of components illustrated in FIG. 1.

Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

Referring to FIG. 1, in its most basic configuration, a computing system 100 typically includes at least one processing unit 102 and memory 104. The memory 104 may be system memory, which may be volatile, non-volatile, or some combination of the two. An example of volatile memory includes Random Access Memory (RAM). Examples of non-volatile memory include Read Only Memory (ROM), flash memory, or the like. The term “memory” may also be used herein to refer to non-volatile mass storage such as physical storage media. Such storage may be removable or non-removable, and may include (but is not limited to) PCMCIA cards, magnetic and optical disks, magnetic tape, and the like.

As used herein, the term “module” or “component” can refer to software objects or routines that execute on the computing system. The different components, modules, engines, and services described herein may be implemented as objects or processes that execute on the computing system (e.g., as separate threads). While the system and methods described herein may be implemented in software, implementations in hardware, and in combinations of software and hardware are also possible and contemplated.

In the description that follows, embodiments of the invention are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other computing systems over, for example, network 110. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### Example of Multi-Mode Logic Programming

As mentioned above, logic programming permits bound and unbound variables to be included in a clause, where the position of the variables within the clause does not necessarily imply anything about whether the variable is bound or unbound. The logic programming may use a complex logic deduction process called unification to solve for the unbound variables. The following logic programming (with line numbering added for clarity) provides an example of the benefits of logic programming and will be referred to throughout the remainder of this description as the “logic programming example”:
1) mode (+,+,−) 1..1
2) mode (−,−,+) 1..*
3) mode (+,+,+) 0..1
4) append(nil,Y,Y).
5) append(cons(H,T),Y,cons(H,Z)):-append(T,Y,Z).

The “Append” proposition of logical programming is an example of the benefits of logical programming and correspondingly the limitations of functional programming, which is a type of rewrite programming. The Append proposition is an example of a reversible proposition, and in this example, takes three arguments. The first three lines define three different modes. If the first two arguments are bound and the last is free, the Append proposition is in the first mode defined in line 1. If the first two arguments are free, and the last is bound, the Append proposition is in the second mode defined in line 2. Finally, if all of the three arguments are bound, the Append proposition is in the third mode defined in line 3. The example includes two Append propositions, one in line 4 and one in line 5.

The Append proposition is used to representing an appending of arguments together into a list. The first two arguments represent the components of the list, and the last argument represents the concatenation of the first two arguments.

If the first two arguments are bound as in mode 1, then the third argument is to be solved for, and will represent a concatenation of the first and second arguments. Since there is only one possible solution for this concatenation, the Append proposition will succeed exactly once (as represented by “1..1” in the mode expression of line 1).

The second mode uses Append in reverse to generate all possible partitions of a list. In this case, the first two arguments are free and the last is bound. Given a list of “n” components (where “n” is the number of indivisible components in the list), there will be n+1 possible divisions assuming that the first or second arguments could represent an empty list while the other of the first or second arguments represents the same list as the third argument.

The third mode uses the Append proposition to test whether the third argument indeed represents a concatenation of the first and second arguments. If it does not, then the proposition fails. Otherwise, the proposition succeeds.

### Trace of Example Logic Programming if in Mode 1

An example of an Append query will now be provided to show how the logic programming above would be evaluated if operating in the first mode defined in line 1. The first example Append query is as follows in Equation 5:

?-Append (cons(1,cons(2,nil)), cons(3,nil),Z) (5)

In this example query, the expression “cons(A,B)” means that A is provided as a prefix for B. Thus, cons(2,nil) is merely 2 since 2 provided as a prefix to nil is simply 2. Furthermore, cons(l,cons(2,nil)) is merely the list (1,2) since 1 provided as a prefix to 2 is simply the list (1,2)

The query would invoke mode 1 of the logic programming logic since the first two arguments of the Append query are bound, and the third argument R is left free. The query will thus try to solve for Z. We can expect one possible result. The unification process tracks the bound and unbound arguments, and thus keeps state indicating that the first two arguments are bound, and the third is unbound.

To solve the query, each of the two Append propositions of the logic programming example are evaluated. The first Append proposition of line 4 does not apply since nil is not the first argument of the Append query. However, the second Append proposition of line 5 does apply since the first argument of the Append proposition and the first argument of the Append query have similar forms, and can be made equal by binding the argument values. The comparison of the values of the first argument (i.e., cons(1,cons(2,nil))) of the Append query and the values of the first argument (i.e., cons(H,T)) of the second Append proposition are used to assign the following bindings:

H1=1

T1=cons(2,nil)

Furthermore, the comparison of the second argument (i.e., cons(3,nil)) of the Append query and the second argument (i.e., Y) of the second Append proposition is used to make the following binding:

Y1=cons(3,nil)

In all of these examples, since recursion will be required, H1 represents the binding of H in the first execution of the Append proposition when the Append proposition is at the highest level of a recursion or perhaps not operating recursively at all. H2 represents the binding of H in the second execution of the Append proposition when operating in a second level of recursion, and so forth. Similar numerical suffices will be used for other variables as well to indicate the level of the recursion in which the binding occurs.

In evaluating the second Append proposition in the first level of recursion, the Append proposition must be evaluated again due to the expression Append(T,Y,Z) at the conclusion of the second proposition.

Calling Append(T,Y,Z) uses the arguments from the first recursion level to internally generate the following Append query:

?-Append(cons(2,nil),cons(3,nil),Z1)

In this second recursion, once again, the first two arguments are bound, and the third argument is free, causing the second recursion to execute in mode 1 defined in line 1 of the logic programming example above.

In this second recursion, the first Append proposition of line 4 is not applicable since the first argument is not nil. Once again, however, the second Append proposition of line 5 does apply since the first argument of the Append proposition and the first argument of the Append query have similar forms. The comparison of the first argument of the Append query (i.e., cons(2,nil)) and the first argument of the second Append proposition (i.e., cons(H,T)) is used to assign make the following bindings in the second recursion of the Append proposition:

H2=2

T2=nil

Furthermore, the comparison of the second argument of the Append query (i.e., cons(3,nil)) and the second argument of the second Append proposition (i.e., Y) is used to make the following binding in the second recursion of the Append proposition:

Y2=cons(3,nil)

The Append proposition must be evaluated again due to the expression Append(T,Y,Z) at the conclusion of the second proposition thereby entering a third recursion of the Append proposition.

Calling Append(T,Y,Z) for entering the third recursion uses the arguments from the second recursion level to internally generate the following Append query:

?-Append(nil,cons(3,nil),Z2)

Here, the Append query matches the Append proposition of line 4, but not the Append proposition of line 5. Also, once again, the Append proposition is evaluated in mode 1 since the first two arguments are bound, and the last argument is free. Accordingly, matching the second argument of the Append query to the Append proposition of line 4, the following binding is made:

Y3=cons(3,nil)

The third unbound argument of the Append proposition of line 4 is the same as the bound argument of the Append proposition of line 4. Therefore, the third recursion of the Append proposition returns the following binding to the second recursion of the append proposition:

Z2=cons(3,nil)

With Z2 being solved for, the unbound variable cons(H,Z) of the second recursion (equivalent to cons(H2,Z2)) may then be solved for and returned to the first recursion of the Append proposition. Specifically, the second recursion of the Append proposition returns the following binding to the first recursion of the append proposition:

Z1=cons(2,cons(3,nil))

With Z1 being solved for, the unbound variable cons(H,Z) of the first recursion (equivalent to cons(H1,Z1)) may then be solved for and returned as the query result. Specifically, the first recursion of the Append proposition returns the following binding to the first recursion of the append proposition:

Z=cons(1, cons(2,cons(3,nil)))

### Trace of Example Logic Programming if in Mode 2

If the first two arguments are free as in mode 2, then the third argument is bound, and the first two arguments are to be solved for. In this case, the solutions for the first two arguments will be the set of possible components that, when concatenated, form the third argument. Since there are n+1 possible solution for this concatenation (wherein “n” is the length of the third argument), the Append proposition will succeed n+1 times (as represented by “1..*” in the mode expression of line 2 in the logic programming example).

An example of an Append query for mode 2 will now be provided as follows in Equation 6:

?-Append (A,B,cons(1,nil)) (6)

To solve the query, each of the two Append propositions of the logic programming example are again evaluated. The first Append proposition of line 4 applies since the third argument of the query may be considered to match that third argument of the first Append proposition. Thus, the following binding is performed:

Y1=cons(1,nil)

The first Append proposition states that the second argument is the same as the third argument, in which case the first argument is simply nil. Thus, evaluation of the first Append proposition against the query of Equation 6 results in the following two bindings as well:

B1=cons(1,nil)

A1=nil

### Accordingly, one solution to the query of Equation 2 is (nil,cons(1,nil),cons(1,nil)), which was obtained without the need for recursion.

The second Append proposition is then evaluated against the query of Equation 6. The third argument of the query (i.e., cons(1,nil)) matches the third argument of the second Append proposition (cons(H,Z)) by making the following bindings:

H1=1

Z1=nil

The Append(T,Y,Z) proposition represented in the last portion of the Second Append proposition is then called to enter the second recursion of the Append proposition. In this case, the following internal query is made substituting Z1 in for Z:

Append(T1,Y1,nil)

In this second recursion, the first Append proposition of line 4 matches (or can be made to match by making further bindings), but the second Append proposition of line 5 does not. The following bindings are thus made in the second recursion:

Y2=nil

T2=nil

The second recursion then returns, whereupon the value of T2 is assigned as to the value T1, and the value of Y2 is assigned to the value Y1. Accordingly, upon return of the second recursion of the Append proposition, the following bindings are made:

T1=nil

Y1=nil

Furthermore, the following binding had already been made:

H1=1

Z1=nil

From this information, the first two arguments of the first Append proposition may then be determined. The first argument (i.e., cons(H,T)) would be cons(1,nil). The second argument (i.e., Y) would be nil. Upon return of the first recursion of the Append proposition, thereby, the following bindings would be made:

A=cons(1,nil)

B=nil

Thus, the response to the query of Equation 6 would be (cons(1,nil),nil,cons(1,nil)) for the second Append proposition. Thus, the two solutions for the query would be:

(nil,cons(1,nil),cons(1,nil)) (solution 1)

(cons(1,nil),nil,cons(1,nil)) (solution 2)

### Trace of Example Logic Programming if in Mode 3

Now a trace of an example Append query that follows the third mode of line 3 of the logic programming example will be provided. The following query represents an example of an Append query in which all three arguments are bound as in Equation 7A:

Append(cons(1,nil),cons(2,cons(3,nil)),cons(1,cons(2,cons(3,nil)))) (7A)

All three arguments of this Append query are bound. Thus, this Append query will simply test whether or not the third argument indeed represents a concatenation of the first two arguments.

Since the first argument is not nil, the first Append proposition of line 4 in the logic programming example does not apply. However, the second Append proposition of line 5 of the logic programming example does apply. Specifically, the first argument of the second Append proposition (i.e., cons(H,T)) can be made to match the first argument of the Append query of Equation 7A (i.e., cons(1,nil)) by making the following bindings.

H1=1

T1=nil

Furthermore, the second argument of the second Append proposition (i.e., Y) can be made to match the second argument of the Append query of Equation 7A (i.e., cons(2,cons(3,nil)) by making the following binding.

Y1=cons(2,cons(3,nil))

Lastly, the third argument of the second Append proposition (i.e., cons(H,Z) can be made to match the third argument of the Append query of Equation 7A (i.e., cons(1,cons(2,cons(3,nil)))) by making the following binding:

Z1=cons(2,cons(3,nil))

### Recall that the value H1 has already been bound to 1, which is consistent with the binding of Z1 to match the values of the third arguments.

The Append proposition (i.e., Append(T,Y,Z)) is then called with the o m bound values of T1, Y1 and Z1 to enter the second recursion level. Specifically, the following internal Append query is made:

?-Append(nil,cons(2,cons(3,nil)),cons(2,cons(3 ,nil)))

This second recursion of the Append query matches the first Append proposition of line 4, since the first argument is nil, and the second and third arguments are equal. The first Append proposition is thus executed with no inconsistencies, and thus returns empty. The second Append proposition is not executed in the second recursion since the first argument of the Append query (i.e., nil) cannot be made to match the first argument of the second Append proposition (i.e., cons(H,Z)). Since there have been no inconsistencies during execution, the first recursion of the Append query will then return empty which indicates that the query is true. The third argument of the query of Equation 7A does indeed represent a concatenation of the first two arguments.

A trace of a second example Append query that follows the third mode of line 3 of the logic programming example will be provided. The following query represents an example of an Append query in which all three arguments are bound as in Equation 7B:

?-Append(cons(1,nil),nil, cons(2,nil)) (7B)

### However, unlike the Append query of Equation 7A, the Append query of Equation 7B will return false, indicating that the third argument does not represent a concatenation of the first two arguments.

Since the first argument is not nil, the first Append proposition of line 4 in the logic programming example does not apply. However, the second Append proposition of line 5 of the logic programming example does apply. Specifically, the first argument of the second Append proposition (i.e., cons(H,T)) can be made to match the first argument of the Append query of Equation 7B (i.e., cons(1,nil)) by making the following bindings.

H1=1

T1=nil

Furthermore, the second argument of the second Append proposition (i.e., Y) can be made to match the second argument of the Append query of Equation 7B (i.e., nil) by making the following binding.

Y1=nil

Lastly, the third argument of the second Append proposition (i.e., cons(H,Z) can be made to match the third argument of the Append query of Equation 7B (i.e., cons(2,nil)) by making the following binding:

H1=2

Z1=nil

However, the binding of H1=2 used to match the third arguments is inconsistent with the binding of H1=1 used to match the first arguments. Therefore, the Append query will return false, indicating that the third argument is not a concatenation of the first two arguments.

As can be seen by these example query traces, logic programming involves careful consideration of which arguments are bound and which arguments are not bound. Through a complex process of unification, the logic programming solves for the unbound arguments, where the processing flow may differ considerably depending on which arguments are bound, and which are not. This complex processing often requires functionality that is not offered by some common runtime environments. Furthermore, runtime execution of logic programming is slower due to its complexity.

In accordance with embodiments of the present invention, logic programming is transformed into rewrite programming. Rewrite programming does not involve tracking which arguments are bound or unbound. Accordingly, the execution of the rewrite programming is less complex and faster. Furthermore, the rewrite programming need not rely on external common runtime environments other than that associated with the rewrite programming language.

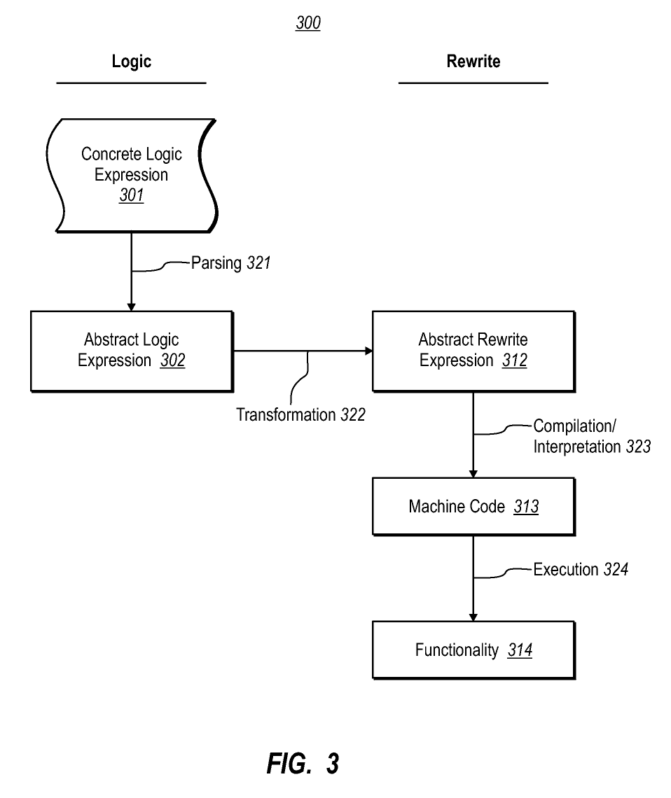

FIG. 2 illustrates a flowchart of a method 200 for transforming logic programming into rewrite programming in accordance with the embodiments of the principles of the present invention. FIG. 3 illustrates a schematic environment 300 including symbolic representations of concrete and abstract expressions of logic and rewrite programming, and various relevant transformations. Symbolic representations of logic programming are represented in the left column of FIG. 3 under the heading “Logic”, while symbolic representations of rewrite programming are represented in the right column of FIG. 3 under the heading “Rewrite”. As the method 200 of FIG. 2 may be performed in the environment 300 of FIG. 3, the method 200 of FIG. 2 will now be described with frequent reference to environment 300 of FIG. 3.

According to the method 200 of FIG. 2, a concrete expression of logic programming is converted into an abstract expression of logic programming (act 201). Referring to FIG. 3, the concrete logic expression 301 is converted into an abstract logic expression 302 as represented by arrow 321. In conventional logic programming, the concrete logic expression 301 may be, for example, source code for logic programming. For instance, the logic programming example presented and discussed in detail above is an example of the concrete logic expression 301 of FIG. 3.

Conventionally, concrete logic programming is converted into a hierarchical tree where each node in the tree abstractly represents a variable or argument or other component of the logic programming. Branches in the hierarchical tree represent functional and/or structural relationships between the components represented by the node at each end of the branch. The hierarchical tree is an example of the abstract logic expression 302 of FIG. 1.

The process 321 of converting the concrete logic expression 301 to the abstract logic expression 302 is often referred to as “parsing” and is a process that is known in the art. Having said this, embodiments of the present invention may not even perform this parsing process 321, but may instead simply access the abstract logic expression 302 to perform the transformation.

Regardless of how the abstract logic expression is accessed, the method 200 transforms (as represented by arrow 322) the abstract logic expression 302 into an abstract expression of rewrite programming 312 (act 202). This transformation will be described in much further detail below with respect to the logic programming example referred to above. This transformation 322 may be automated by programming a computing system to implement the features of the transformation process described below.

Once the abstract rewrite expression 312 is obtained through the transformation process 322, the abstract rewrite expression 312 may be compiled or interpreted (act 203 and arrow 323 in FIG. 3) to generate a compiled or interpreted representation of rewrite programming (also referred to as “machine code rewrite programming) 313. This machine code rewrite programming 313 may then be executed (act 204 and arrow 324) to generate functionality 314 that results from the execution.

Thus, operations that are provided by logic programming that may be alternatively provided by rewrite programming. An example of such functionality is Append, which is realized as two Append propositions in the logic programming example provided above. By transforming the logic programming into rewrite programming, the execution of the rewrite programming is much faster.

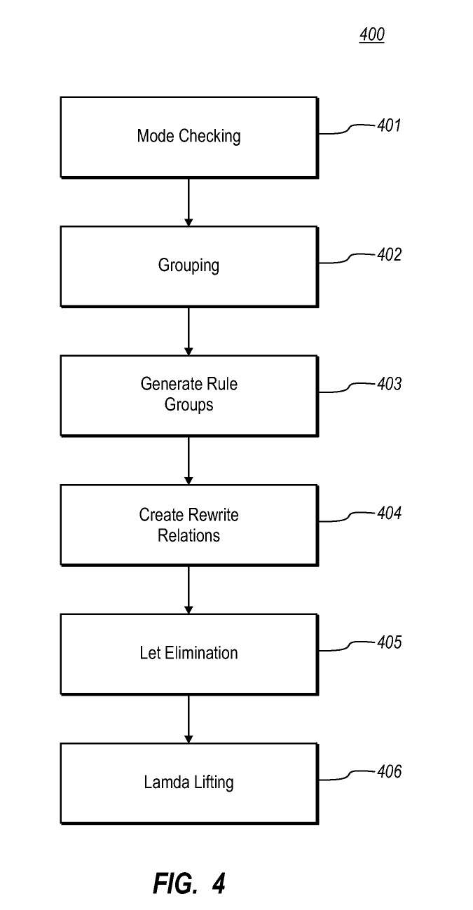

FIG. 4 illustrates a flowchart of a method 400 for transforming an abstract logic expression into an abstract rewrite expression in accordance with embodiments of the present invention. The method 400 represents a specific example of the act 202 of FIG. 2. The following example transformation shows how the transformations may take place with respect to the concrete logic and rewrite expressions (i.e., with respect to transforming logic source code into rewrite source code). This is for purposes of working with concrete expressions that are more intuitive to the most human readers as compared to abstract expressions. However, one of ordinary skill in the art would be able to infer the corresponding transformations on the abstract expressions given the following description of the transformations of the concrete expressions.

Referring to FIG. 4, the logic programming is examined for mode checking (act 401). In one embodiment, this may be accomplished by examining mode declarations within the logic programming. For instance, by examining lines 1-3 of the logic programming example presented above, the transformation program may automatically detect that the logic programming works in three different modes. In another embodiment, however, the modes may be inferred without the use of expressed mode declarations. A static semantic check ensures that the mode's arity matches each clause's arity and that the clauses' predicate names are the same. In a mode inference algorithm, the applicable modes are inferred from the statement. In one example, if there are “n” (wherein n is a whole number) total arguments, each of the “n” squared (n̂2) modes would be subjected to the transformation process described herein. If the transformation failed, it would be determined that those modes simply do not apply, and thus only the modes that were successfully transformed would be used.

After identifying the modes of operation (act 401), the clauses are broken into groups each with a single mode, arity, and clause name (act 402). This will sometimes require duplication. The append example, may result in three groups matching the three modes, since the arity (i.e., 3 arguments per proposition) is the same for each clause, and clause name “i.e., Append” is the same for each clause. As expressed in concrete syntax, the three groups for the logic programming example may as follows:

Group 1
mode(+,+,−) 1..1
append(nil,Y,Y).
append(cons(H,T),Y,cons(H,Z)):-append(T,Y,Z).
Group 2
mode(−,−,+) 1..*
append(nil,Y,Y).
append(cons(H,T),Y,cons(H,Z)):-append(T,Y,Z).
Group 3
mode(+,+,+) 0..1
append(nil,Y,Y).
append(cons(H,T),Y,cons(H,Z)):-append(T,Y,Z).

Following this grouping operation (act 402), the transformation program may generate a rule group (act 403) for each of the groups generated by the grouping operation. In the logic programming example, three rule groups would be generated. After sorting, each clause group has a single mode which stipulates a directed transformation of ground terms from the inputs (+) to the outputs (+). This meets the definition of a term rewrite system.

The intermediate phases of compilation use an abstraction that is similar to a functional programming language (which is typically limited to only possible normal form) to allow for zero or many normal forms. The pseudo code below is a convenient representation of the intermediate form. The code is intended to look something like functional code (specifically ML). The main difference is the use of “relation” and “+” rather than “function” and “|” to highlight the possibility of zero or many normal forms.

An example of rules generated during this rule generation process are provided below in XML format:

```
<xfm:rule name=“append.iio”>
  <xfm:all/>
  <xfm:ruleGroup op=“All”>
  <xfm:pattern>
    <append.iio>
    <nil>
    </nil>
    <xfm:var name=“Y”/>
    </append.iio>
  </xfm:pattern>
  <xfm:action>
    <Tuple>
    <xfm:var name=“Y”/>
    </Tuple>
  </xfm:action>
  <xfm:pattern>
    <append.iio>
    <cons>
      <xfm:var name=“H”/>
      <xfm:var name=“T”/>
    </cons>
    <xfm:var name=“Y”/>
    </append.iio>
  </xfm:pattern>
  <xfm:action>
    <append.iio.2.1>
    <append.iio>
      <xfm:var name=“T”/>
      <xfm:var name=“Y”/>
    </append.iio>
    <xfm:var name=“H”/>
    <xfm:var name=“T”/>
    <xfm:var name=“Y”/>
    </append.iio.2.1>
  </xfm:action>
  </xfm:ruleGroup>
</xfm:rule>
<xfm:rule name=“append.iio.2.1”>
  <xfm:all/>
  <xfm:ruleGroup op=“All”>
  <xfm:pattern>
    <append.iio.2.1>
    <Tuple>
      <xfm:var name=“Z”/>
    </Tuple>
    <xfm:var name=“H”/>
    <xfm:var name=“T”/>
    <xfm:var name=“Y”/>
    </append.iio.2.1>
  </xfm:pattern>
  <xfm:action>
    <Tuple>
    <cons>
      <xfm:var name=“H”/>
      <xfm:var name=“Z”/>
    </cons>
    </Tuple>
  </xfm:action>
  </xfm:ruleGroup>
</xfm:rule>
```

After rule generation (act 403), a relation is created for each group (act 404). For clarity the name is the clause's head's predicate name appended with the mode. Since “+” and “−” are not allowed in names in XML or most programming languages “i” and “o” are used in the pseudo code. Thus, under this naming syntax, the Append proposition operating in mode 2 would be called the Append.iio relation upon conversion to a rewrite system. The Append proposition operating in mode 2 would be called the Append.ooi relation upon conversion to rewrite. The Append proposition operating in mode 3 would be called Append.iii upon conversion to rewrite.

The input arguments are placed in a tuple on the left hand side of the relation. The output arguments are the return value on the right hand side. For a clause with no antecedents, this is all that is performed. If there are antecedents, these antecedents are translated as nested lets and the return value is the scope of the innermost let. Each antecedent is a predicate without a mode specification. An appropriate mode is determined based on the variables that are bound at its point of use.

In the second Append clause of the logic programming example, there is a recursive call as is apparent from the tracings set forth in detail above. Consider mode 1 (iio). The variables H, T, and Y are bound in the head and Z is unbound. T is used in the first position of the antecedent so this position is an input variable in the recursive call. Likewise Y in the second position is bound therefore an input. The third position uses Z. Since Z is unbound, the third position is an output. This results in a mode of iio, exactly the same as the head (which is not always the case for all multi-modal recursive calls). This sets up the call for the let. The input variables are passed as actuals. The return is the binding in the let. The scope is the next antecedent or the return value as appropriate.

Upon completion of this act, the concrete expression of the relations in the Append example would appear as follows:

```
Group 1
relation append.iio =
  (nil, Y) ->
    (Y)
  + (cons(H, T), Y) ->
    let
    (Z) = append.iio(T, Y)
    in
    (cons(H, Z))
Group 2
relation append.ooi =
  (Y) ->
    (nil, Y)
  + (cons(H, Z)) ->
    let
    (T, Y) = append.ooi(Z)
    in
    (cons(H, T), Y)
Group 3
relation append.iii =
  (nil, Y, Y) ->
    ( )
  + (cons(H, T), Y, cons(H, Z)) ->
    let
    ( ) = append.iii(T, Y, Z)
    in
    ( )
```

This pseudo code is as it might be printed directly from the compiler's intermediate structures. It shows some flaws that will be corrected for later in the process. As an example, the iii mode of append has a useless let. The action of the second alternative says let append.iii( . . . ) equal nothing in nothing, so the let can be optimized away. The recursive call cannot be eliminated because success or failure of the containing relation.

Upon creation of the initial version of the rewrite relation using act 404, the let function is eliminated (act 405) since “let” is not supported in a rewrite system. In a functional language (recall that a functional language is a type of rewrite language), a let can be eliminated by creating a new function. The scope of the let is the body of the new function. The bindings are established by using the variables as formal arguments and using the call as an actual argument.

In the rewrite system, lets can be eliminated in a similar way. A new relation is created for every let. There are no nested relations, so a top level relation with a new name is created and a call is left in its place. So long as the name of the new relation is unique, the precise name does not matter. For readability, the generated relations are named from the relation name, clause index, and let index. For example, new relation generated for the first let, in the second, clause of the append.iio relation is append.iio.2.1.

The following represents relations generated by this process after let elimiation

```
relation append.iio =
  (nil, Y) ->
    (Y)
  + (cons(H, T), Y) ->
    append.iio.2.1(append.iio(T, Y))
relation append.iio.2.1 =
  (Z) ->
    (cons(H, Z))
```

This is sufficient to eliminate the lets, but it has created a new problem, which are solved in this transformation process. The generated relations will frequently contain free variables. In the example above, “H” is free in the new relation.

Before the new relation is separated representing the completion of the transformation from a logic programming to rewrite programming, all free variables are bound though a process called lambda lifting (act 406). Lambda lifting proceeds bottom up by adding a formal parameter for every free variable in every function and adding an actual parameter at every call sight.

The following are the relations produced by the compiler. The generated functions are at the end of the list. Note that they ignore some or all of their arguments.

```
Group 1
relation append.iio =
  (nil, Y) ->
    (Y)
  + (cons(H, T), Y) ->
    append.iio.2.1(append.iio(T, Y), H, T, Y)
relation append.iio.2.1 =
  ((Z), H, T, Y) ->
    (cons(H, Z))
Group 2
relation append.ooi =
  (Y) ->
    (nil, Y)
  + (cons(H, Z)) ->
    append.ooi.2.1(append.ooi(Z), H, Z)
relation append.ooi.2.1 =
  ((T, Y), H, Z) ->
    (cons(H, T), Y)
Group 3
relation append.iii =
  (nil, Y, Y) ->
    ( )
  + (cons(H, T), Y, cons(H, Z)) ->
    append.iii.2.1(append.iii(T, Y, Z), H, T, Y, Z)
relation append.iii.2.1 =
  (( ), H, T, Y, Z) ->
    ( )
```

In addition to the programming itself, logic queries are transformed into calls of the rewrite system prior to being evaluated by the transformed rewrite relations. Queries are thus translated into calls of the rewrite system. Since an antecedent is a query, the transformation of the query may be essentially the same as described for the antecedents.

Consider the following logic query:

?-append([1], [2,3], X).

The first two arguments are bound, so it will be translated into the call:

append.iio([1], [2,3])

and the return value will be bound to X.

Likewise:

?-append(X,Y,[1,2,3]).

will be translated into

append.ooi([1,2,3])

which will return the four pairs that could be appended to form [1,2,3] as follows:
([ ],[1,2,3])
([1],[2,3])
([1,2],[3])
([1,2,3],[ ])

The first term of each pair will successively be bound to X and the second to Y.

The query:

?-append(X,[2,3],[1,2,3]).

is translated into the call:

append.oii([2,3],[1,2,3])

Since there was no oil mode specified as in the logic programming example above, this query will produce no results. When the oii mode is specified, the result is:
[1]
   as expected.

The execution uses an innermost reduction strategy which corresponds to DFS in logic programming or call by value in programming language semantics.

Return values which contain relation symbols are not constructors and therefore not considered constructor normal forms. These are eliminated in a post processing phase.

The mode system cannot answer queries with arguments that are not either bound or free. For example, the following cannot be answered because the first argument is partially bound.

?-append([1|X],[4,5],[1,2,3,4,5]).

However, this is not a severe limitation. The query above could be represented as:

?-append([1],Y,[1,2,3,4,5]), append(Y,X,[4,5]).

Accordingly, the principles of the present invention provide a mechanism for automatically transforming logic programming into rewrite programming, allowing for the advantages of rewrite programming (such as speed of execution) while avoiding much of the complexities of logic programming.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for transforming logic programming into rewrite programming, the method comprising:
an act of transforming concrete expression of logic programming into an abstract expression of logic programming; and
an act of automatically transforming the abstract expression of logic programming into an abstract expression of rewrite programming.

2. A method in accordance with claim 1, further comprising:
an act of compiling the abstract expression of the rewrite programming into a compiled representation of the rewrite programming.

3. A method in accordance with claim 2, further comprising:
an act of executing the compiled rewrite programming.

4. A method in accordance with claim 3, wherein the act of executing the compiled rewrite programming is performed by using a common runtime environment.

5. A method in accordance with claim 1, wherein the logic programming included an expression that would require unification if the logic programming itself was to be compiled and executed without first being transformed into rewrite programming.

6. A method in accordance with claim 5, wherein the rewrite programming does not require unification.

7. A method in accordance with claim 1, wherein the act of automatically transforming the abstract expression of logic programming into an abstract expression of rewrite programming comprises:
an act of identifying a plurality of modes for the abstract expression of logic programming; and
an act of generating a single mode abstract expression of logic programming for each of the plurality of modes; and
an act of transforming each of the signal mode abstract expressions into a rewrite relation.

8. A method in accordance with claim 7, wherein the act of transforming each of the signal mode abstract expressions includes the following for at least one of the single mode abstract expressions:
an act of transforming the signal mode abstract expression into a rule group defining variables of the signal mode abstract expression; and
an act of generating the corresponding rewrite relation using the rule group.

9. A method in accordance with claim 8, wherein the rule group is expressed in XML.

10. A method in accordance with claim 7, wherein the plurality of modes is identified by evaluating expressed mode declarations.

11. A method for automatically transforming an expression of logic programming into an expression of rewrite programming, the method comprising:
an act of identifying a plurality of modes for the expression of logic programming; and
an act of generating a single mode expression of logic programming for each of the plurality of modes; and
an act of transforming each of the signal mode expressions into a rewrite relation.

12. A method in accordance with claim 11, wherein the expression of logic programming is a concrete expression of logic programming, and wherein the expression of rewrite programming is a concrete expression of rewrite programming.

13. A method in accordance with claim 1T, wherein the expression of logic programming is an abstract expression of logic programming, and wherein the expression of rewrite programming is an abstract expression of rewrite programming.

14. A method in accordance with claim 13, wherein the method further comprises:
an act of accessing a concrete expression of logic programming; and
an act of converting the concrete expression of logic programming into the abstract expression of logic programming.

15. A method in accordance with claim 11, wherein the act of transforming each of the signal mode expressions includes the following for at least one of the single mode expressions:
an act of transforming the signal mode abstract expression into a rule group defining variables of the signal mode abstract expression; and
an act of generating the corresponding rewrite relation using the rule group.

16. A method in accordance with claim 15, wherein the rule group is expressed in XML.

17. A method in accordance with claim 7, wherein the plurality of modes is identified by evaluating expressed mode declarations.

18. A computer program product comprising one or more computer-readable media having thereon computer executable instructions that, when executed by one or more processors of a computing system, cause the computing system to perform a method for transforming logic programming into rewrite programming, the method comprising:
parsing concrete logic programming into an abstract logic programming; and
transforming the abstract logic programming into an abstract rewrite programming.

19. A computer programming product in accordance with claim 18, wherein the one or more computer-readable media are physical memory and/or storage media.

20. A computer program product in accordance with claim 18, wherein the one or more computer-readable media are one or more storage media.
